(19) United States
(12) Patent Application Publication
(10) Pub. No.: US 2007/0297964 A1
(43) Pub. Date: Dec. 27, 2007

(54) COMPOSITIONS COMPRISING MAGNESIUM BOROHYDRIDE AND MAGNESIUM HYDRIDOBOROHYDRIDE AND METHOD FOR MANUFACTURING THE SAME

(76) Inventors: Grigorii Lev Soloveichik, Latham, NY (US); Ji-Cheng Zhao, Latham, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/425,603

(22) Filed: Jun. 21, 2006

(51) Int. Cl. C01B 6/15

(52) U.S. Cl. 423/286; 423/648.1

(57) ABSTRACT

Disclosed herein is a method comprising reacting a metal borohydride with a metal chloride composition in a solvent to form a reaction mixture, wherein the metal chloride composition comprises magnesium chloride; wherein the metal borohydride and the metal chloride composition are insoluble in the solvent; grinding the reaction mixture to produce a composition that comprises magnesium hydridoborohydride; and removing the solvent from the composition. Disclosed herein too is a composition comprising magnesium hydridoborohydride having the formula MgₙH(BH₄)₂ₙ₋₁ where n is about 3 to about 7. Disclosed herein too is a method of manufacturing hydrogen comprising heating a composition comprising magnesium hydridoborohydride.

### BACKGROUND

This disclosure is related to compositions comprising magnesium borohydride, magnesium hydridoborohydride or combinations thereof. This disclosure also relates to methods for manufacturing the aforementioned compositions.

Hydrogen is a “clean fuel” because it can be reacted with oxygen in hydrogen-consuming devices, such as a fuel cell or a combustion engine, to produce energy and water. Virtually no other reaction byproducts are produced in the exhaust. As a result, the use of hydrogen as a fuel effectively solves many environmental problems associated with the use of petroleum based fuels. Safe and efficient storage of hydrogen is, however, essential for many applications that can use the hydrogen fuel. In particular, minimizing volume and weight of the hydrogen storage systems are important factors in mobile applications.

Several methods of storing hydrogen are currently used but these are either inadequate or impractical for widespread mobile consumer applications. For example, hydrogen can be stored in liquid form at very low temperatures. However, the energy consumed in liquefying hydrogen gas is about 30% of the energy available from the resulting hydrogen. In addition, a standard tank filled with liquid hydrogen will become empty in about a week through evaporation; thus dormancy is also a problem. These factors make liquid hydrogen impractical for most consumer applications.

An alternative is to store hydrogen under high pressure in cylinders. However, a 100 pound steel cylinder can only store about one pound of hydrogen at about 2200 psi, which translates into 1% by weight of hydrogen storage. More expensive composite cylinders can store hydrogen at higher pressures of about 4,500 psi using special compressors to achieve a more favorable storage ratio of about 4% by weight. Although even higher pressures are possible, safety factors and the high amount of energy consumed in achieving such high pressures have compelled a search for alternative hydrogen storage technologies that are both safe and efficient. In view of the above, there is a need for safer, more effective methods of storing and recovering hydrogen.

Magnesium borohydride [Mg(BH₄)₂] is a promising material for hydrogen storage and recovery. It comprises up to about 14.8 weight percent (wt %) of hydrogen that can be liberated upon heating. The use of magnesium borohydride is limited by the absence of convenient methods for its manufacture. It is therefore desirable to have a convenient method for manufacturing magnesium borohydride.

### SUMMARY

Disclosed herein is a method comprising reacting a metal borohydride with a metal chloride composition in a solvent to form a reaction mixture, wherein the metal chloride composition comprises magnesium chloride; wherein the metal borohydride and the metal chloride composition are insoluble in the solvent; grinding the reaction mixture to produce a composition that comprises magnesium hydridoborohydride; and removing the solvent from the composition.

Disclosed herein too is a composition comprising magnesium hydridoborohydride having the formula MgₙH(BH₄)₂ₙ₋₁ where n is about 3 to about 7.

Disclosed herein too is a method of manufacturing hydrogen comprising heating a composition comprising magnesium hydridoborohydride.

### DESCRIPTION OF FIGURES

FIG. 1 is an infra-red (IR) spectrum in nujol showing the presence of the boron-hydrogen bonds for magnesium hydridoborohydride MgₙH(BH₄)₂ₙ₋₁;

FIG. 2 is an X-ray diffraction (XRD) pattern characteristic for magnesium hydridoborohydride MgₙH(BH₄)₂ₙ₋₁ phase; and

FIG. 3 is a graphical representation showing a differential calorimetry scan conducted at 10° C./min for the magnesium hydridoborohydride from run 5 that has the formula Mg₃H(BH₄)₅.

### DETAILED DESCRIPTION

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable.

It has been inadvertently discovered that a composition comprising magnesium borohydride and magnesium hydridoborohydride (hereinafter the “composition”) can be manufactured by reacting a metal borohydride with magnesium chloride while grinding the reaction mixture in the presence of a solvent during the course of the reaction. The reaction mixture comprises the metal borohydride and a metal chloride composition that comprises magnesium chloride and a suitable solvent. In an exemplary embodiment, the grinding is accomplished in a ball mill. Disclosed herein therefore is a method for manufacturing the composition that comprises reacting a metal borohydride and a metal chloride composition that comprises magnesium chloride and other optional metal chlorides in a solvent wherein reactants are practically insoluble in the solvent but the target product is soluble, and wherein solubility and reactivity of reactants during the reaction is enhanced by grinding during the reaction. The reactions are conducted in such a solvent to produce thermally unstable solvated borohydride complexes that decompose upon heating to yield an unsolvated composition.

As noted above, the composition is produced by the reaction between a metal borohydride and magnesium chloride when the reactants are ground during the reaction. Insolubility of the starting reactants and some of the reaction products hinder the rate of reaction and hence the reaction yields. It is therefore desirable to increase the rate of reaction by facilitating the dissolution of the reactants during the reaction. Grinding has been discovered to be one effective method for refreshing the surface of reactants. During the grinding, insoluble reaction products are displaced from the surface of the reactants. Upon displacement of the insoluble reaction products, reactive surfaces are exposed to each other thereby promoting an increased rate of dissolution. The amount and type of grinding can be varied to facilitate the dissolution of insoluble solids during the reaction.

Examples of suitable metal borohydrides are those wherein the metal cation is an alkali metal, an alkaline earth metal, a transition metal, or the like, or a combination comprising at least one of the foregoing metals. Exemplary metal borohydrides are sodium borohydride, potassium borohydride, calcium borohydride, strontium borohydride, or the like, or a combination comprising at least one of the foregoing borohydrides.

As noted above, while magnesium chloride is generally used to produce the composition, other metal chlorides can also be used. Other metal chlorides that can be used are magnesium chloride complexes whose metal cation is selected from an alkali metal or an alkaline earth metal, or the like. Exemplary magnesium chloride complexes are lithium magnesium chloride (Li₂MgCl₄), sodium magnesium chloride (NaMgCl₃) or a combination comprising at least one of the foregoing magnesium chloride complexes.

The molar ratio of the borohydride group (BH₄) (in the metal borohydrides) to the magnesium chloride is about 2:1 to about 6:1 respectively. An exemplary molar ratio of the borohydride group (BH₄) to the magnesium chloride is about 2:1 to about 3:1 respectively. When a magnesium chloride complex is used instead of the magnesium chloride, then an exemplary molar ratio of the borohydride group in the metal borohydrides to the total magnesium is about 2:1 to about 3:1.

As noted above, it is desirable for the solvent in which the reaction is conducted to not dissolve the reactants (the metal borohydride and magnesium chloride composition). In an exemplary embodiment, the solvent also does not dissolve the metal chloride formed as a result of the reaction between the metal borohydride and the magnesium chloride. It is also desirable for the solvent to not dissolve any of the other reaction products with the exception of the magnesium borohydride produced during the reaction. It is also desirable for the solvent to be extractable from the solvated magnesium borohydride without promoting the decomposition of the unsolvated magnesium borohydride compound.

A suitable solvent for conducting the reaction is an alkyl ether. Examples of suitable alkyl ethers are methyl ether, ethyl ether, propyl ether, or the like, or a combination comprising at least one of the foregoing alkyl ethers. Another exemplary solvent is an alkyl amine.

The molar ratio of the solvent to the reactants is about 2:1 to about 500:1. An exemplary molar ratio of the solvent to the reactants is about 50:1 to about 100:1.

The reactants together with the solvent are subjected to grinding during the reaction. In other words, the reactants are ground in a wet state during the reaction. The reaction is generally conducted at a temperature of up to about 100° C. An exemplary reaction temperature is about 20 to about 35° C.

Examples of grinding include ball milling, milling in a Wiley mill, hammer milling, rod milling, semi autogenous (SAG) milling, autogenous milling, pebble milling, milling using high pressure grinding rolls, milling in a Buhrstone mill, or the like, or a combination comprising at least one of the foregoing grinding operations. Ball milling using inert balls are generally preferred. Exemplary ball mills are rolling or planetary ball mills.

The ball mill, a type of grinder, is a device used to grind (or mix) materials like ores, chemicals, ceramics and paints. The ball mill may rotate around a horizontal axis, a vertical axis, or an axis inclined between the horizontal and the vertical, partially filled with the material to be ground in addition to the grinding medium. An internal cascading effect reduces the reactants to a fine powder during the process. The grinding medium is preferably ceramic balls, or stainless steel balls coated with a ceramic. An exemplary ceramic is tungsten carbide. Industrial ball mills that can operate continuously, with reactants fed at one end and products discharged at the other can also be used. The amount and size of balls, as well as size of the vessel are selected to provide effective grinding of insoluble solids during the reaction. Rolling or planetary ball mills can be used for this purpose. The grinding refreshes the surface of the reactants thus accelerating the reaction.

The total time for grinding depends upon the ratio of volume of grinding media (balls) to the volume of solid reactants that are being reacted, and the speed of the ball mill rotation. In general, for a reaction volume of about 100 to about 350 milliliters, it is desirable for the grinding to be conducted for a period of about 24 hours to about 72 hours. An exemplary reaction time is about 48 hours, when the reaction volume is about 100 milliliters. The reaction volume is the total volume of the metal borohydride, the magnesium chloride and optional metal chlorides along with the solvent.

After the reaction is completed, the insoluble unreacted metal borohydride and any metal chloride complexes produced during the reaction may be removed from the reaction mixture by separation process such as membrane separation, filtration, decantation, precipitation, centrifugation, or the like, or a combination comprising at least one of the foregoing separation processes. Solvent may then be removed from solution containing the composition by evaporation, optionally in vacuum, to form a solid or liquid solvate of the borohydride complex. If the solvate has a limited solubility in the solvent, then the remaining insoluble part of the solvate is isolated from the precipitate by solvent extraction. After the isolation of the solvate, the unsolvated compound comprising magnesium borohydride and magnesium hydridoborohydride can be recovered by heating the solvate to a temperature of about 180 to about 250° C. in a vacuum of about 0.01 to about 10 Torr.

In one exemplary embodiment, in one method of manufacturing the composition, sodium borohydride (NaBH₄) is reacted with magnesium chloride (MgCl₂) in a ball mill. Tungsten carbide balls can be used in the ball mill. The sodium borohydride (NaBH₄) is reacted with magnesium chloride (MgCl₂) in a molar ratio of 2:1 in the presence of diethyl ether to produce solvated magnesium borohydride at ambient temperature and pressure as shown in equation (I).

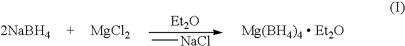

where Et₂O represents the ethyl ether solvent. The resulting solvated magnesium borohydride is isolated and then heated to a temperature of about 180° C. to about 235° C. to yield the unsolvated composition comprising magnesium hydridoborohydride as demonstrated in equation (II). An exemplary temperature for the desolvation is about 235° C.

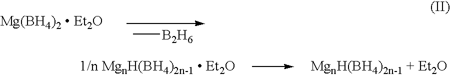

where MgₙH(BH₄)₂ₙ₋₁ represents the magnesium hydridoborohydride, wherein n can be about 3 to about 7. According to elemental analysis, at this stage of the reaction, the weight ratio of boron to magnesium (B:Mg) is less than 2. This indicates the presence of magnesium borohydride and magnesium hydridoborohydride [MgₙH(BH₄)₂ₙ₋₁] where n is about 3 to about 7. In one embodiment, n is about 3 to about 4.

In one embodiment, the composition comprises magnesium borohydride and magnesium hydridoborohydride in a molar ratio of about 2:1 to about 5:1. An exemplary ratio of magnesium borohydride to hydridoborohydride is about 3:1 to about 4:1. The yield of magnesium borohydride is from 40 to about 80%, based on the amount of magnesium borohydride that could be theoretically obtained.

Thus in summary, conducting the reaction in a ball mill in a solvent under grinding (wet grinding) increases the yields significantly over yields from a similar reaction that is conducted either in the absence of grinding or in the absence of solvent (dry grinding conditions). In one embodiment, the reaction yields for reactions conducted under wet grinding conditions are increased by about 10% over reactions that are conducted under dry grinding conditions. In another embodiment, the reaction yields for reactions conducted under wet grinding condition are increased by about 25% over reactions that are conducted under dry grinding conditions. In yet another embodiment, the reaction yields for reactions conducted under wet grinding conditions are increased by about 35% over reactions that are conducted under dry grinding conditions.

When the reaction is conducted under grinding the reaction yields are generally greater than or equal to about 70%. In one embodiment, the reaction yields are greater than or equal to about 75%. In another embodiment, the reaction yields are greater than or equal to about 80%. In yet another embodiment, the reaction yields are greater than or equal to about 85%.

In one embodiment, the compound can be heated to a temperature of greater than or equal to about 395° C. to produce hydrogen. Hydrogen is generally produced in amounts of about 12.4 to about 14.8 wt %, based on the weight of the composition.

The following examples, which are meant to be exemplary, not limiting, illustrate reaction as well as methods of manufacturing of some of the various embodiments of the magnesium hydridoborohydrides described herein.

### EXAMPLES

### Example 1

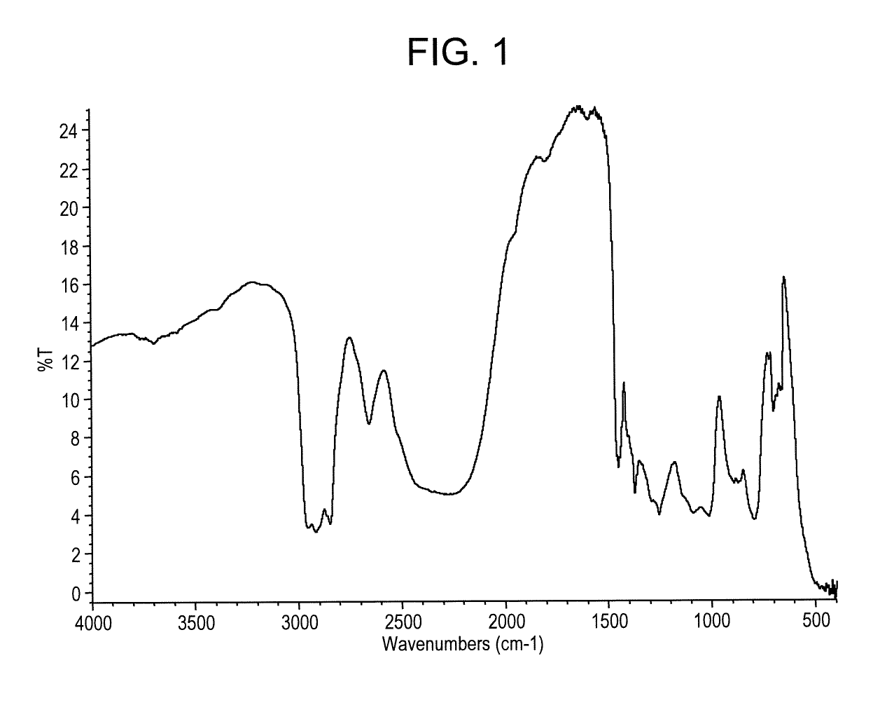

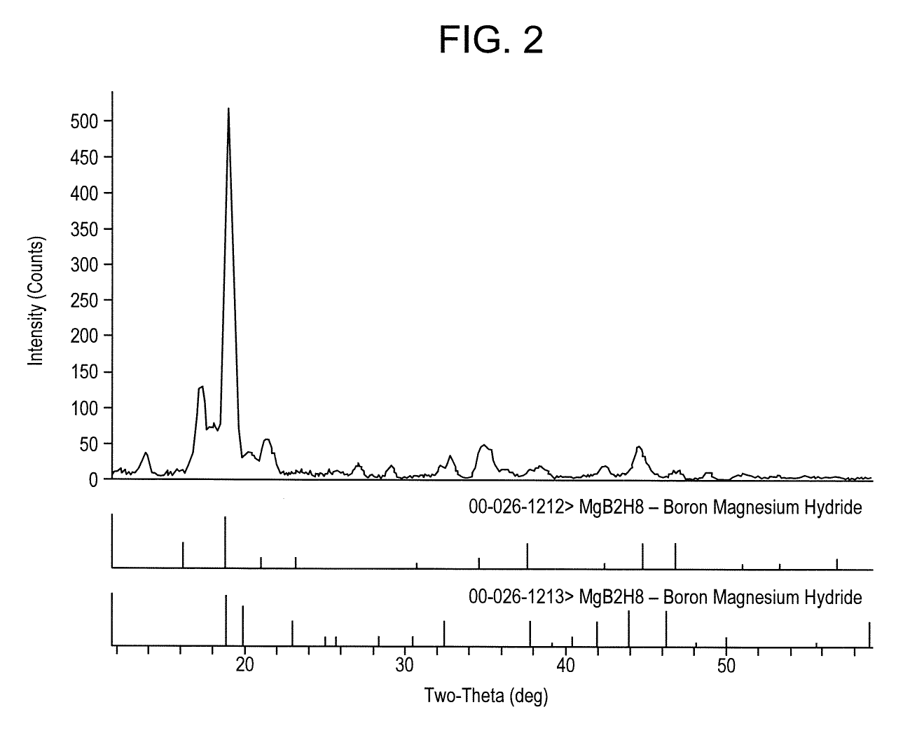

This reaction was performed to demonstrate the reaction between sodium borohydride and magnesium chloride in a ball mill to produce the composition comprising magnesium borohydride and magnesium hydridoborohydride. A stainless steel cylindrical container with inner diameter 2.5 inch was charged with 3.0 grams (g) (31.5 mmol) magnesium chloride (MgCl₂), 3.6 g (5 mmol) sodium borohydride (NaBH₄), 120 mL ethyl ether (Et₂O), and 20 balls each having a diameter of 0.5 inch. The container was sealed with a copper seal and placed on a roller. The rolls had a diameter of 2.5 inches. The reaction mixture was balled milled for 72 hours with rotation speed about 60 rpm. The reaction mixture was filtered in vacuum through a medium glass frit. Evaporation of ether from the filtrate in vacuum and heating of resulting solid to 235° C. produced a white solid. The yield was 1.21 grams (71%). An infra-red (IR) spectrum of this solid in nujol shown at FIG. 1 indicates the presence of magnesium hydridoborohydride and demonstrates the presence of the B—H bonds. FIG. 2 is an X-ray diffraction (XRD) pattern of the reaction product that is characteristic for the MgₙH(BH₄)₂ₙ₋₁ phase. This diffraction pattern does not significantly change for different values of “n”.

### Example 2

These reactions were performed to demonstrate differences in yield when the reaction between sodium borohydride and magnesium chloride is conducted under different conditions. Ethyl ether was used as a solvent in all runs except Run 3 where the solvent was used only for extraction after ball-milling. The reactions were conducted under the conditions shown in the Table 1. Runs 1, 2 and 3 represent comparative runs where forms of agitation comprising magnetic stirring, dispersion and dry ball milling were respectively used. During Run 2, dispersion was conducted at 18,000 rpm using an ULTRA TURRAX® disperser. During Run 2, fresh portions of Et₂O were added to compensate for the solvent loss due to evaporation. Run 3 represents a comparative run where dry ball-milling followed by solvent extraction with diethyl ether was used. Runs 4-7 were conducted using wet ball milling (i.e., ball milling of the reactants in the presence of a solvent). The yields are shown in the Table 1.

In each run, the reaction mixture was agitated at room temperature using the method described in Example 1 for 36 hours and filtered through a medium glass frit. Evaporation of ether in vacuum and heating of resulting solid to 235° C. produced a white solid. The yields are shown in the Table 1. From the Table 1 it can be seen that under wet ball milling, the yields are increased significantly over dry ball milling and magnetic stirring. The atomic ratio of boron to magnesium is from 1.57 to 1.79 for the samples that have been wet ball milled, indicating the formation of the compound of the formula MgₙH(BH₄)₂ₙ₋₁ where n is equal to 3 to 5 comprising both magnesium borohydride and magnesium hydridoborohydride.

TABLE 1

| | Synthesis | | | | | | | | |
|---|---|---|---|---|---|---|---|---|---|
| | | | | Wt. ratio | | | Analysis | | |
| | | | | of MgCl₂ | | | | | Wt. |
| | Agitation | MgCl₂, | NaBH₄, | to | Et₂O, | | Mg, | | ratio |
| Run | method | grams | grams | NaBH₄ | mL | Yield, % | wt. % | B, wt. % | B:Mg |
| 1 | Magnetic | 3.0 | 3.6 | 3.0 | 250 | 0 | — | — | — |
| (comparative) | stirring | | | | | | | | |
| 2 | Dispersing | 5.0 | 6.0 | 3.0 | 250 | 2.3 | — | — | — |
| (comparative) | | | | | | | | | |
| 3 | Dry ball | 11.4 | 11.0 | 2.4 | — | 1.2 | 41.6 | 33.1 | 1.79 |
| (comparative) | milling | | | | | | | | |
| 4 | Wet ball | 3.0 | 2.4 | 2.0 | 120 | 70.5 | 47.1 | 32.9 | 1.57 |
| | milling | | | | | | | | |
| 5 | Wet ball | 20.1 | 24.2 | 3.0 | 350 | 40.4 | 49.5 | .36.4 | 1.66 |
| | milling | | | | | | | | |
| 6 | Wet ball | 20.0 | 25.0 | 3.2 | 120 | 75.7 | 43.6 | 33.9 | 1.75 |
| | milling | | | | | | | | |
| 7 | Wet ball | 30.0 | 36.0 | 3.0 | 350 | 66.2 | 43.7 | 34.2 | 1.76 |
| | milling | | | | | | | | |

As can be seen from the Table 1, the atomic ratio of boron to magnesium in all samples prepared by wet ball milling (Runs 4-7) of magnesium chloride with an excess of sodium borohydride is less than 2. All samples display the same IR spectrum. The X-ray diffraction patterns shown in the FIG. 2 do not change from synthesis to synthesis or after additional thermal or mechanical treatments. This indicates the presence of a single phase that does not change upon thermal or mechanical treatments. The material was further characterized by using high-resolution x-ray diffraction (wavelength 0.69127 Å) at the National Synchrotron Light Source at the Brookhaven National Laboratory. The diffraction pattern can be indexed by an orthorhombic unit cell with the following dimensions: a=18.531 Å, b=9.322 Å, c=5.455 Å and cell volume, V=942.33 Å³.

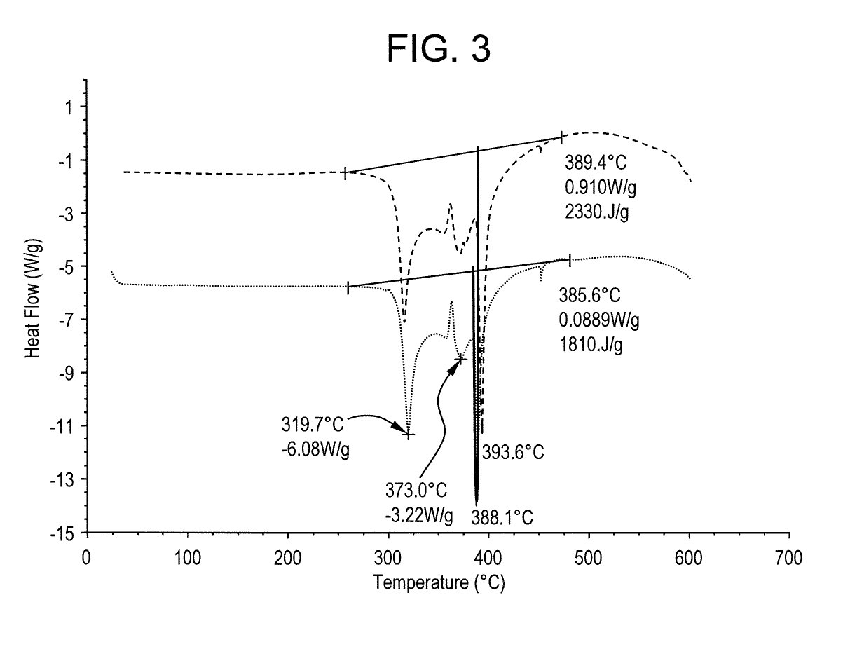

FIG. 3 depicts two spectra obtained from thermal experiments performed on different samples of the composition using differential scanning calorimetry at heating rate of 10° C./minute. Both runs reflect similar thermal behavior indicating that a consistent composition is produced.

The presence of both magnesium hydridoborohydrides and magnesium borohydrides in the composition was further confirmed by reaction with tetramethylethylenediamine (TMEDA). The treatment of an ether solution of MgₙH(BH4)₂ₙ₋₁ with tetramethylethylenediamine causes precipitation of white sediment, which, according to an elemental analysis, is the complex MgH(BH₄).TMEDA. In contrast, the complex Mg(BH₄)₂.TMEDA can be isolated by crystallization from the filtrate.

Table 2 reflects elemental content for the magnesium borohydride and the magnesium hydridoborohydrides. From the Table 2 it may be seen that the atomic ratio of boron to magnesium for magnesium hydridoborohydrides is less than 2, while that for magnesium borohydride is 2.

TABLE 2

| | | | Wt. Ratio |
|---|---|---|---|
| Formula | Mg, wt. % | B, wt. % | B:Mg |
| Mg(BH₄)₂ | 45.02 | 40.04 | 2 |
| Mg₅H(BH₄)₉ | 47.45 | 37.99 | 1.80 |
| Mg₄H(BH₄)₇ | 48.10 | 37.44 | 1.75 |
| Mg₃H(BH₄)₅ | 49.22 | 36.44 | 1.67 |
| MgH(BH₄) | 60.52 | 26.89 | 1 |

Thus, it may be seen that the grinding of the reactants during wet ball milling produces significantly higher yields than similar process where grinding is not used. In addition, the reaction can proceed much more rapidly than processes where grinding is not used.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A composition comprising:
magnesium hydridoborohydride having the formula MgₙH(BH₄)₂ₙ₋₁ where n is about 3 to about 7.

2. The composition of claim 1, wherein n is about 3 to about 4.

3. The composition of claim 1, further comprising magnesium borohydride.

4. A method comprising:
reacting a metal borohydride with a metal chloride composition in a solvent to form a reaction mixture, wherein the metal chloride composition comprises magnesium chloride; wherein both the metal borohydride and the metal chloride composition are insoluble in the solvent;
grinding the reaction mixture to produce a composition that comprises magnesium hydridoborohydride; and
removing the solvent from the composition.

5. The method of claim 4, further comprising separating the magnesium hydridoborohydride from insoluble reactants and reaction products.

6. The method of claim 4, wherein the grinding is conducted using ball milling, milling in a Wiley mill, hammer milling, rod milling, semi autogenous milling, autogenous milling, pebble milling, milling using high pressure grinding rolls, milling in a Buhrstone mill, or a combination comprising at least one of the foregoing grinding operations.

7. The method of claim 4, wherein the ball milling is conducted a rolling ball mill or in a planetary ball mills.

8. The method of claim 4, wherein the removing of the solvent is conducted in a vacuum.

9. The method of claim 4, wherein the metal borohydride is sodium borohydride, potassium borohydride, calcium borohydride, or a combination comprising at least one of the foregoing metal borohydrides.

10. The method of claim 4, wherein the metal chloride composition comprises a metal chloride in addition to the magnesium chloride.

11. The method of claim 4, wherein a molar ratio of a borohydride (BH₄) group in the metal borohydride to magnesium chloride in the metal chloride composition is about 2:1 to about 6:1.

12. The method of claim 4, wherein a molar ratio of a borohydride (BH₄) group in the metal borohydride to magnesium chloride in the metal chloride composition is about 2:1 to about 3:1.

13. The method of claim 4, wherein a molar ratio of the solvent to the sum of the metal borohydride and the metal chloride composition is about 50:1 to about 100:1.

14. The method of claim 4, wherein the solvent is an alkyl ether.

15. The method of claim 14, wherein the alkyl ether is methyl ether, ethyl ether, propyl ether, or a combination comprising at least one of the foregoing alkyl ethers.

16. The method of claim 4, wherein the solvent is an alkyl amine.

17. The method of claim 4, wherein removing the solvent is conducted via evaporation in vacuum.

18. A method of manufacturing hydrogen comprising:
heating a composition comprising magnesium hydridoborohydride.

19. The method of claim 18, wherein the heating is conducted to a temperature of greater than or equal to about 395° C.

20. The method of claim 18, wherein the hydrogen is released in an amount of about 12.4 to about 14.8 wt %, based on a total weight of the composition.

21. The method of claim 18, wherein the composition further comprises magnesium borohydride.
